(19) United States
(12) Patent Application Publication
(10) Pub. No.: US 2026/0133752 A1
(43) Pub. Date: May 14, 2026

(54) SYSTEMS AND METHODS FOR AUTOMATIC AUDIO EXPERIENCE CUSTOMIZATION BASED ON RIDABLE DEVICE CONTEXT

(71) Applicant: SCOOTASONIX LTD, Beckenham (GB)

(72) Inventors: Stephen Roderick HARAKIS, Beckenham (GB); Michael Roger HARAKIS, Rome (IT)

(21) Appl. No.: 19/378,865

(22) Filed: Nov. 4, 2025

Related U.S. Application Data
(60) Provisional application No. 63/719,139, filed on Nov. 12, 2024.

(51) Int. Cl. G06F 3/16; B62J 45/10; B62J 50/21; H04R 1/02

(52) U.S. Cl. CPC G06F 3/165; B62J 45/10; B62J 50/21; G06F 3/162; H04R 1/025; H04R 2499/13

(57) ABSTRACT

Devices, systems, and methods are disclosed for customizing audio experiences associated with operation of a ridable device. An electronic device having a processor detects contextual information such as speed, acceleration, ambient noise level, environment type, or location of the ridable device. Sensor data from accelerometers, gyroscopes, microphones, cameras, or positioning systems may be processed to identify these conditions. Based on the detected context, the electronic device determines audio configuration parameters, including selection of audio content, adjustment of volume, blending of tracks, or modification of tempo or pitch. The determined parameters are applied to output audio through one or more speakers of the electronic device, the ridable device, or associated accessories. In some implementations, playback is synchronized with other riders using a common time reference, geo-fence triggers are employed to provide location-specific content, or warning sounds are generated when nearby objects are detected, enhancing both rider enjoyment and environmental awareness.

### TECHNICAL FIELD

The present disclosure generally relates to systems, methods, and devices for providing experiences that involve music, sound effects, and other audio to riders on electric scooters and other ridable devices.

### BACKGROUND

Users of ridable devices, including electric scooters, bicycles, motorcycles, and other vehicles, often desire to listen to music, alerts, or other audio during operation. The users typically use smart phones and other portable devices to manually select songs, adjust volume, or otherwise configure the audio experience. Such manual adjustments may be inconvenient, distracting, or unsafe, particularly while navigating busy streets or crowded environments.

### SUMMARY

Various implementations disclosed herein include systems, devices, and methods for customizing audio output for users of ridable devices based on contextual information. For example, a control unit may obtain data from one or more sensors associated with a ridable device, such as speed, acceleration, ambient noise level, geographic location, or environment type, and determine one or more audio parameters. These parameters may be used to adjust volume, tempo, pitch, or track composition of audio content. By automatically configuring audio output according to riding context, the system enhances rider enjoyment and safety without requiring manual adjustments.

In some implementations, audio customization comprises selectively adjusting a plurality of audio tracks that form a sound or song. For example, as a scooter speed increases, additional components such as bass, guitar, or percussion may be introduced, or volumes of individual tracks may be scaled. In other implementations, audio adjustments include changing pitch or tempo to match riding conditions, such as increasing tempo for faster speeds. Such dynamic control may provide the rider with an enriched experience and may also alert nearby pedestrians to the approach of the ridable device.

In some implementations, the system initiates audio playback automatically based on detecting that the user is riding a ridable device. For example, a mobile application may analyze accelerometer or gyroscope data to recognize when the device is in motion and begins playback without user input. Contextual triggers may also include entering a predefined geographic region, detecting ambient sound levels, or communicating with a scooter-mounted accessory.

In some implementations, contextual adjustments are applied to enhance awareness of the rider's surroundings. For instance, the system may increase volume in noisy environments, play warning tones when other riders or pedestrians are within a threshold distance, or output location-specific content such as tourist information or advertising tied to nearby landmarks. Geo-fences may also be used to configure particular playlists or sound effects when the rider enters defined areas, such as a campus or commercial district.

In some implementations, the system synchronizes audio playback across multiple riders. For example, audio tracks may be aligned to a global positioning system (GPS) clock such that multiple users hear the same song segments simultaneously. Synchronization may avoid tempo changes that could interfere with group riding experiences while still adjusting volume or track balance according to individual rider context.

In some implementations, the audio customization system is embodied as a mobile device application configured to interact with scooter-mounted speakers or cradles. In other implementations, the control unit, player, and speakers are integrated directly into the ridable device itself. In either case, the system may further use external data sources such as weather reports, time of day, or user calendar entries to refine audio adjustments.

In some implementations, the system adjusts audio based on scooter speed by selecting which portions of a music file are presented as the speed changes. For example, a sound file may be split into multiple tracks or sound components (e.g., drums, vocals, guitar, keyboard, or different frequency ranges). As the scooter accelerates, additional tracks or components are gradually introduced to create a richer, fuller sound—starting, for instance, with only percussion at low speeds and progressively layering in bass, guitar, and higher-frequency elements at higher speeds. In some cases, the adjustments may involve changes in volume, pitch, or tempo. Where multiple riders are synchronizing playback, tempo adjustments may be avoided to maintain consistency across devices. This dynamic adjustment of audio serves both functional and experiential purposes: it can provide audible cues to others regarding scooter speed while simultaneously enhancing the rider's enjoyment by enriching the soundscape as speed increases.

In some implementations, the audio adjustment system may select which portions of the sound content such as tracks, sound components, instruments, or frequency ranges to include based on the scooter's speed. For example, the sound content may be divided into multiple components, and as the scooter accelerates, additional components are introduced. The playback may begin with a base layer, such as drums, and progressively add other elements, such as bass, guitar, and keyboard, as speed increases. Music files may also include sound components such as musical riffs, melodies, sound effects, loops, or other acoustic elements, which are gradually incorporated as speed thresholds are reached. The system may further adjust the frequency balance, adding higher-frequency elements like percussion or bass tones at higher speeds to produce a richer overall sound. In some cases, the amount of sound integrated into playback increases with scooter speed to create a fuller audio experience. Adjustments may also include modifications to pitch or tempo, although tempo changes may be avoided during synchronized playback among multiple riders to maintain consistent timing. Generally, these dynamic sound adjustments can serve dual purposes: providing audible cues that reflect changes in scooter speed or movement and enhancing the rider's emotional engagement such as increasing excitement or joy as the sound becomes fuller and more immersive with speed.

In general, one innovative aspect of the subject matter described in this specification can be embodied in methods, at an electronic device having a processor and a display, that include the actions of detecting that a ridable device is moving at a first speed. The detection may be performed using one or more sensors, such as a motion sensor, a global positioning system (GPS) sensor, or another suitable mechanism for determining movement or velocity. Based on detecting that the ridable device is moving at the first speed, the electronic device selects a first audio component of a multi-component audio content item. The first audio component may correspond, for example, to a first track among multiple tracks, a particular instrument sound, or a specific frequency range within the overall audio composition. The system then outputs audio that includes the first audio component.

When the ridable device is subsequently detected as moving at a second speed that is different from the first speed, for example, when the device accelerates or decelerates into another speed range, the electronic device selects a second audio component of the multi-component audio content item and outputs audio including the second audio component. This allows the playback to dynamically adjust in real time as the speed of the ridable device changes, providing a responsive and engaging audio experience for the rider.

These and other implementations may each optionally include one or more of the following features.

In some implementations, a device includes one or more processors and a non-transitory computer-readable storage medium coupled to the one or more processors. The storage medium may store program instructions that, when executed by the one or more processors, cause the system to perform operations comprising detecting that a ridable device is moving at a first speed, selecting a first audio component of a multi-component audio content item, and outputting audio that includes the first audio component. Based on detecting that the ridable device is moving at a second speed that is different from the first speed, the program instructions may further cause the system to select a second audio component of the multi-component audio content item and output audio that includes the second audio component. In this way, the device dynamically adjusts the audio output based on the changing speed of the ridable device, providing a responsive and context-aware playback experience.

In some implementations, the system further enables synchronization of sound or music playback across multiple riders or devices. For example, the method may include determining to synchronize audio output on multiple ridable devices based on a detected criterion. The criterion may indicate that the devices are associated with a same user account, that user input on one or more devices has manually linked the devices, or that both devices are wirelessly attached to speakers associated with one another. In such cases, subsequent changes to the audio—such as the inclusion of additional audio components or volume adjustments based on context—may also be synchronized across devices.

In some implementations, a common time reference may be identified for synchronizing the audio output across the multiple ridable devices. For example, the devices may communicate directly with one another, each may access a coordinating server, or both may reference the same external clock source, such as a global positioning system (GPS) clock. Once the common time reference is established, in some implementations the devices may synchronize the audio output such that each device plays the corresponding sound segments or song portions in unison. In some implementations, synchronization information may be provided by a coordinating server or by a designated primary device that shares playback timing information with the other devices. This synchronization ensures that multiple riders experience consistent and harmonized audio playback during shared riding sessions.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates an example of a user operating a ridable device with an electronic system configured to provide audio output, in accordance with some implementations.

FIG. 2 illustrates an example schematic representation of a ridable device system including components for detecting context and providing audio output, in accordance with some implementations.

FIG. 3 illustrates an example graph depicting relationships between ridable device operation and audio characteristics, in accordance with some implementations.

FIG. 4 illustrates an example table showing audio configuration settings for adaptive output, in accordance with some implementations.

FIG. 5 illustrates an example flow diagram of a process for adapting audio output based on detected speeds of a ridable device, in accordance with some implementations.

FIG. 6 illustrates an example flow diagram of a process for synchronizing audio playback across multiple ridable devices, in accordance with some implementations.

FIG. 7 illustrates an example block diagram of an electronic device configured for contextual detection and audio management, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

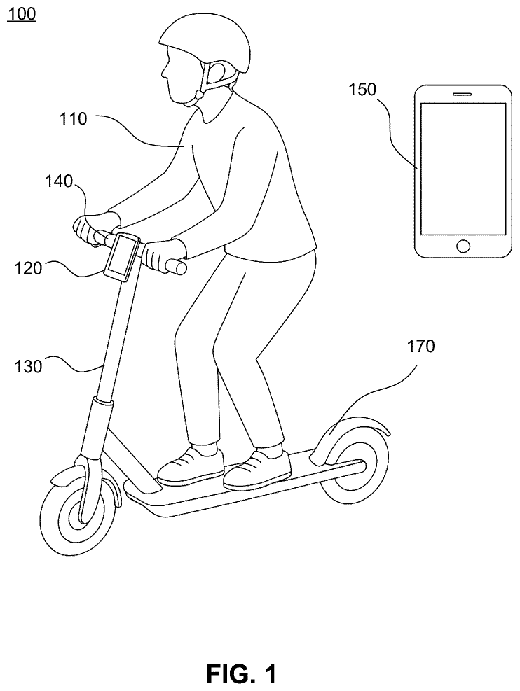

FIG. 1 illustrates an example ridable device system 100 that may be utilized with the automatic audio experience customization techniques described herein. The system 100 includes a user operating a ridable device 170. In various implementations, the ridable device 170 may take the form of an electric-powered scooter, a manually powered kick scooter, a bicycle, or an electric bicycle (e-bike). In other embodiments, the ridable device 170 may be a motorcycle, a Segway-style personal transporter, a hoverboard, or an electric skateboard. Additional examples of the ridable device 170 may include a go-kart, an all-terrain vehicle (ATV), a motorized wheelchair, or an electric unicycle. In further cases, the ridable device 170 may encompass seasonal or sport-oriented vehicles such as powered skis or snowboards, or wearable wheeled systems such as roller skates or inline skates. The user may also wear a helmet and other protective gear for safety. Depending on the particular form of the ridable device 170, the user may operate the device from a standing position, a seated straddling position, a reclined position, or another supported posture. More generally, the ridable device 170 may represent any human-powered or motorized conveyance configured to transport the user.

The scooter 170 may include a handlebar assembly 140 that the user grips with both hands. The handlebar assembly 140 may include one or more integrated controls and sensors. For example, a mounting unit or cradle 120 may be attached to the central portion of the handlebar assembly 140. The mounting unit 120 is configured to hold, secure, or otherwise support an electronic device in a position visible to the rider. In some implementations, the electronic device may be a smartphone. In other implementations, the electronic device may include a tablet computer, a portable media player, a navigation system, a camera, a wearable computing device, or a dedicated communication module. The mounting unit 120 may be implemented as a removable cradle, clamp, bracket, or docking station, and may employ fasteners, spring-loaded arms, magnetic coupling, or adhesive structures to retain the electronic device. In certain embodiments, however, the ridable device itself, such as the scooter 170, may be originally manufactured, equipped, or sold with an integrated mounting structure. Such a configuration may include a built-in recess, dashboard, or housing adapted to receive and support the electronic device without requiring a separate holder. Thus, the mounting unit 120 may either be provided as an accessory component attachable to the scooter 170 or may be pre-installed or integrated into the scooter 170 as part of its original equipment. The mounting unit 120 or integrated support may further include adjustable joints or pivots to allow the device to be positioned at a desired viewing angle relative to the rider and may be designed to orient one or more speakers of the electronic device to direct sound forward relative to the user, thereby enhancing projection of audio. More generally, whether implemented as an add-on cradle or as an integrated feature of the scooter 170, the mounting unit 120 may be configured to provide visibility, accessibility, and audio or data output suitable for operation during use of the ridable device.

The scooter frame 130 may support the user and may include a foot deck, front wheel, and rear wheel. In various implementations, the scooter may further incorporate integrated speakers, microphones, or sensors, such as speed sensors, accelerometers, gyroscopes, or cameras, to detect contextual information about the riding environment (e.g., speed, acceleration, proximity of pedestrians, ambient noise conditions, or geo-location).

Also illustrated in FIG. 1 is a mobile device 150 (e.g., a smartphone). In some implementations, the mobile device 150 may be placed in the holder 120 on the scooter's handlebar assembly, while in other implementations the device may be carried separately by the user. The mobile device 150 may include one or more processors and a non-transitory storage medium storing instructions that, when executed, enable determination of contextual information and adjustment of an audio experience based on that context. For example, the mobile device 150 may execute an application that detects scooter speed or location and automatically adjusts audio volume, tempo, track blending, or other output parameters to suit the detected context.

In some implementations, the device 150 may communicate wirelessly with components integrated into the scooter 170, such as embedded sensors or speakers, to coordinate contextual detection and audio output. In other implementations, the smartphone itself may include all components (e.g., control unit, player, microphone, and speakers) necessary for contextual audio customization.

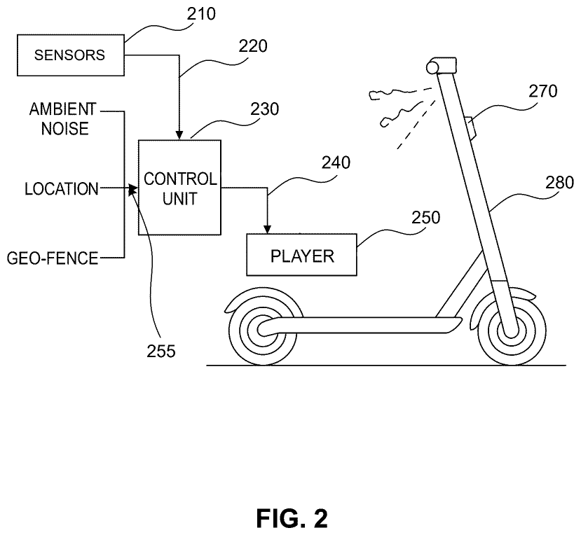

FIG. 2 illustrates an example system architecture for automatic audio experience customization based on a ridable device context. In this example, a ridable device 280, shown here as a scooter, includes multiple electronic subsystems configured to determine contextual information, process such information, and generate customized audio output for a user.

A set of sensors 210 may provide contextual data to the system. Such sensors may include a speed sensor, inertial measurement unit (IMU), accelerometer, gyroscope, microphone(s) for ambient noise detection, camera(s) for detecting environment type or nearby obstacles, and positioning hardware (e.g., GPS receiver). The sensor array 210 may capture information 255 such as speed, acceleration, ambient noise levels, location, and whether the device is inside or outside a geo-fenced area. Additional contextual parameters, such as time of day, weather conditions, traffic density, or proximity to other road users, may also be incorporated.

The sensor output may be transmitted via a signal path 220 to a control unit 230. The control unit 230 may be configured to analyze the contextual information, either through deterministic algorithms or through machine-learning models trained to detect patterns indicative of riding conditions. Based on such analysis, the control unit 230 determines appropriate audio parameters such as track selection, volume level, pitch, tempo, or effect overlays. For instance, the control unit may increase audio volume with increased scooter speed, modify sound effects when the rider enters a crowded urban zone, or trigger specific warning tones when another object is detected nearby. The control unit 230 may further enforce geo-fence rules, such as muting or limiting playback when the rider enters restricted areas.

The control unit 230 may communicate the processed commands along a communication channel 240 to a player 250. The communication channel 240 may be implemented using a variety of technologies, including wired connections (e.g., USB, auxiliary audio cable, or dedicated data bus within the ridable device 280) and wireless connections (e.g., Bluetooth, Wi-Fi, near-field communication (NFC), cellular, or proprietary short-range radio frequency protocols). In some implementations, the communication channel 240 may be a hybrid system capable of dynamically switching between wired and wireless connections based on signal strength, device availability, or user preferences, thereby providing redundancy and ensuring seamless operation.

The player 250 may be a digital media player integrated into the ridable device 280 or may be part of a coupled electronic device such as a smartphone, tablet, or wearable headset. In operation, the player 250 retrieves and outputs audio content (e.g., stored media files, streaming audio from an online service, or system-generated alerts and tones) in accordance with the contextual parameters set by the control unit 230. In some implementations, the player 250 may further support adaptive audio processing, such as decomposing a track into individual stems or layers (e.g., drums, bass, vocals) and selectively adjusting the mix, applying sound effects, or balancing frequencies. These adjustments may be made in real time in response to conditions such as vehicle speed, acceleration, ambient noise levels, user biometric signals, or environmental context, thereby enhancing safety, immersion, and personalization of the riding experience. Audio output is projected via the speaker(s) 270 mounted to the ridable device 280. The speakers 270 may be directed forward to enhance projection to both the user and surrounding pedestrians, thereby increasing awareness of the approaching scooter. In some embodiments, the ridable device 280 may be pre-equipped with such speakers and mounts, while in other embodiments a separate cradle or holder may position a user's smartphone such that its own speakers provide the output. The audio may be further routed through auxiliary channels such as wireless earbuds, helmet-mounted speakers, or external Bluetooth devices.

The scooter 280 may also incorporate a structural housing that supports the integration of the sensors, control unit, player, and speakers. In variations, these components may be distributed between the ridable device 280 and a detachable user device. For example, a smartphone may provide the control unit 230 and player 250 functionality, while the scooter frame 280 provides integrated speakers 270 and power supply.

Accordingly, FIG. 2 illustrates how contextual information 255 captured by sensors 210 is processed by the control unit 230 and applied by the player 250 to generate customized audio output via speakers 270, thereby enhancing both user experience and environmental awareness during operation of the ridable device 280.

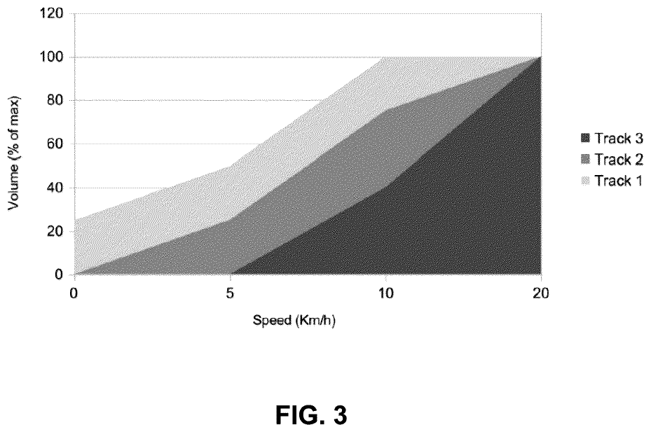

FIG. 3 illustrates an example configuration in which multiple audio tracks or audio components may be dynamically adjusted as a function of ridable device speed. In this illustrative graph, the horizontal axis represents speed of the ridable device in kilometers per hour (km/h), while the vertical axis represents playback volume as a percentage of maximum output. Three separate audio tracks, Track 1, Track 2, and Track 3, are depicted, though in practice each “track” may correspond to any audio component, such as an instrument part, a frequency band, or a distinct sound effect.

At low speeds, Track 1 may be initialized with a baseline output level of approximately 25% volume even when the ridable device is stationary, thereby providing a consistent background sound. As speed increases to around 5 km/h, the volume of Track 1 rises to 50% and continues to increase, reaching 100% volume at speeds of 10 km/h and above. Track 2, by contrast, remains silent at 0% volume until the device reaches a threshold of about 5 km/h, after which its output gradually ramps up, reaching 75% volume at 10 km/h and 100% volume at the maximum speed of 20 km/h. Track 3 demonstrates an even more gradual introduction: it remains muted until about 10 km/h, begins increasing in volume thereafter, and reaches full output at 20 km/h.

In some implementations, each track may represent not just a pre-recorded layer but a functional audio element chosen to build the soundscape in stages. For instance, Track 1 may correspond to drums or percussion, providing a rhythmic baseline that is always audible. As the ridable device accelerates, Track 2 may add bass, enriching the low-frequency content. At still higher speeds, Track 3 may introduce guitar, vocals, or additional melodic instruments, progressively filling out the audio mix. In other configurations, the components may correspond to frequency ranges, with low frequencies enabled first and higher frequencies added at faster speeds, creating a balanced progression from minimal to complex sound.

The adjustment of volumes and track inclusion may be continuous and proportional, ensuring smooth transitions. For example, when GPS or motion sensor data produces sudden fluctuations in measured speed (such as when passing through a tunnel or losing signal), the system may apply smoothing or hysteresis functions to avoid jarring changes. In certain embodiments, the introduction of tracks or sound components follows defined speed thresholds, such that each new component is introduced only after the ridable device enters a corresponding speed range.

This progressive layering provides both functional and experiential benefits. Functionally, it can act as an audible signal to others, with richer or more intense audio correlating with higher scooter speeds, thereby conveying awareness of motion. Experientially, the rider benefits from a dynamic soundtrack that evolves with their ride: at slow speeds, a simple beat or ambient background is heard; as acceleration increases, additional instruments, vocals, or effects enter, creating a fuller and more immersive sound. For sound effect-oriented implementations, early tracks may include subtle ambiance, while later tracks introduce bolder elements such as electronic beats, engine roars, or themed cues (e.g., “laser sounds”) that intensify with speed.

In some embodiments, tempo, pitch, or other parameters may also be adjusted in real time. For example, pitch or tempo of one or more tracks may increase with speed to reinforce the sense of acceleration, while in multi-user scenarios the system may deliberately avoid tempo shifts to preserve synchronization across devices. Contextual factors beyond speed, such as ambient noise level or location, may further influence which components are selected or how they are mixed. For instance, higher frequencies may be emphasized in noisy city streets, while certain tracks may be substituted when the rider enters a designated geo-fenced area.

Accordingly, FIG. 3 illustrates an implementation in which dynamic scaling and selective inclusion of multiple audio components is used to enrich the rider's experience, provide situational awareness to the environment, and deliver an adaptive soundscape that responds directly to ridable device speed and surrounding context.

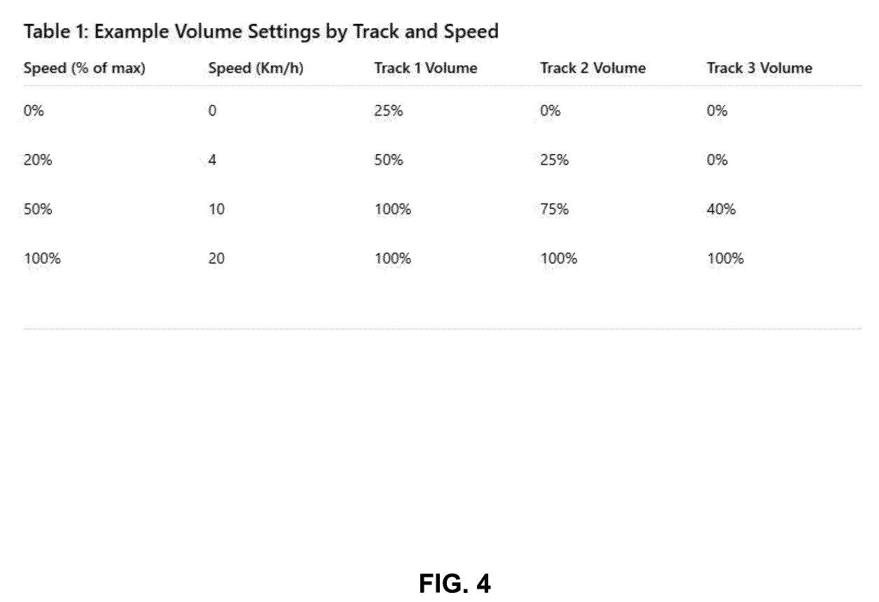

FIG. 4 illustrates an example configuration table (Table 1) that may define playback levels for multiple audio components as a function of ridable device speed. In this table, speed is expressed both as a percentage of the maximum ridable device speed and as an absolute value in kilometers per hour (km/h). Each row maps these speed values against playback output levels of three audio components (Track 1, Track 2, and Track 3). While three tracks are illustrated, in practice the system may manage any number of components, including individual instruments, sound effects, or frequency bands.

At 0% of maximum speed (0 km/h), Track 1 is configured to output at 25% of its maximum volume, thereby establishing a constant audio presence even when the ridable device is stationary. This creates an ambient or rhythmic foundation that signals system readiness and provides a sense of continuity. At this same speed, Track 2 and Track 3 remain muted, ensuring the stationary rider experiences a minimal soundscape that is unobtrusive in quiet environments.

At 20% of maximum speed (approximately 4 km/h), Track 1 ramps up to 50% volume, Track 2 activates at 25% volume, and Track 3 remains silent. The addition of Track 2 begins to layer the soundscape with complementary elements, such as a bassline or secondary instrument, which both enriches the listening experience and provides audible feedback that the ridable device has begun to accelerate.

At 50% of maximum speed (approximately 10 km/h), Track 1 reaches full output at 100% volume, Track 2 increases to 75% volume, and Track 3 initiates playback at 40% volume. At this stage, the rider begins to experience a fuller and more immersive sound environment. For musical configurations, this may correspond to the introduction of vocals, guitar, or keyboard layers, while for sound-effect-oriented profiles, additional cues such as synthetic beats, environmental simulations, or themed effects may be introduced.

At 100% of maximum speed (approximately 20 km/h), all three tracks—Track 1, Track 2, and Track 3—are configured to output at 100% of their maximum volume. At this level, the rider hears the complete, intended mix or composition, with all components contributing equally to deliver a peak intensity audio experience. This “full build” provides not only emotional excitement for the rider but also conveys to nearby listeners or pedestrians that the ridable device is traveling at high speed.

In some implementations, the specific values in Table 1 are not fixed but may be configurable by either the system or the user. These values may be stored as part of a customizable audio profile that can be selected prior to riding, or they may be dynamically modified in real time. For instance, adjustments may account for ambient noise (e.g., automatically boosting high-frequency content in loud traffic), environment type (urban versus rural routes), or personal preference (e.g., favoring vocals over instrumentals). This flexibility allows the same underlying framework to produce tailored experiences for different contexts and riders.

By defining discrete speed thresholds and corresponding output levels, Table 1 provides a structured framework for generating adaptive audio experiences. While the illustrated example shows linear increases and three layers, other variations may employ non-linear scaling, a larger number of tracks, or frequency-band based divisions. These mappings ensure that as speed increases, the audio output becomes richer and more complex, while smoothing functions prevent abrupt changes due to momentary speed fluctuations.

Accordingly, FIG. 4 demonstrates how playback tables can be used to progressively activate and balance multiple audio components at predefined speed intervals. This approach ensures that the rider experiences a dynamically evolving soundscape that reflects their speed and environment, enhances personal enjoyment, and provides contextual awareness to others in the vicinity.

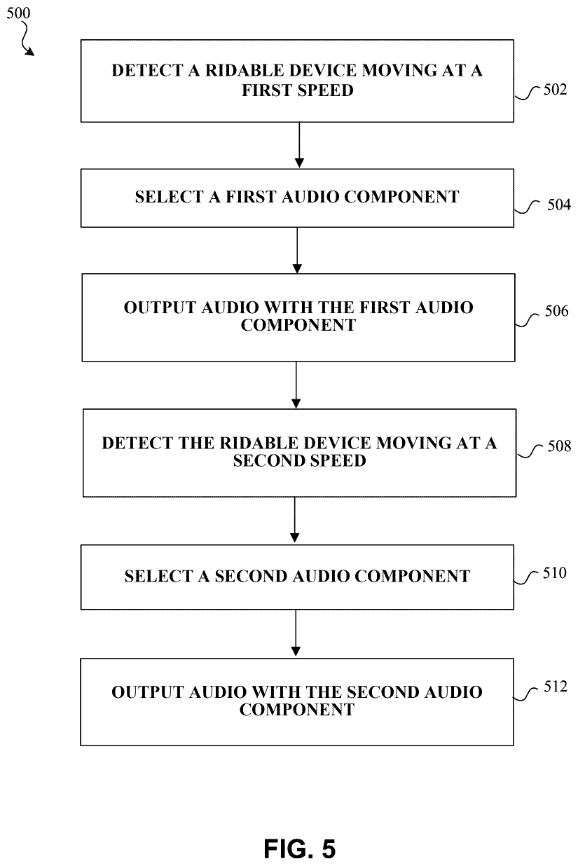

FIG. 5 is a flow diagram illustrating an example method 500 for customizing audio output in connection with the operation of a ridable device. The method 500 is executed at an electronic device that includes a processor, memory, and input/output components, and may be implemented in hardware, software, or a combination of both. The electronic device may be integrated directly with the ridable device or may be embodied in a mobile device such as a smartphone that is removably attached to the ridable device. Audio may be delivered through integrated speakers, wireless speakers, or through speakers of the mobile device itself.

At block 502, the method may include detecting that the ridable device is moving at a first speed. The detection of speed may be accomplished by one or more sensors, including a global positioning system (GPS) sensor, an accelerometer, or a gyroscope. In some implementations, combinations of these sensors provide a more accurate indication of speed and motion. For example, accelerometer and gyroscope readings may capture changes in acceleration or orientation, while GPS provides positional data that can be converted into speed over time. The detected first speed establishes the initial riding condition used to guide subsequent audio selection.

At block 504, the method may include selecting a first audio component of a multi-component audio content item. The multi-component audio content may consist of multiple instrument tracks, layered sound effects, or divided frequency ranges. The first audio component may correspond to a single musical instrument such as percussion, or it may represent a lower frequency portion of the overall audio content. In some implementations, the first audio component functions as a base layer that may play at lower speeds, creating a minimal or foundational auditory experience that reflects slower motion.

At block 506, the method may include outputting audio with the first audio component. This output may be provided through one or more speakers associated with the ridable device or through external speakers connected wirelessly. The playback of the first audio component not only entertains the rider but may also provide audible cues that make the motion of the ridable device perceptible to surrounding pedestrians or nearby traffic.

At block 508, the method may include detecting that the ridable device is moving at a second speed that is different than the first speed. The second speed may be higher or lower than the first speed, and detection may once again rely on motion sensors or GPS data. The continual monitoring of speed allows the system to dynamically determine whether the riding condition has changed and whether a different audio experience should be presented.

At block 510, the method may include selecting a second audio component of the multi-component audio content item. The second audio component may correspond to a different musical instrument track, a higher frequency portion of the audio content, or an additional audio layer intended to enrich playback when the device is moving faster. In some examples, as speed increases, additional components may be gradually introduced, resulting in fuller and more complex soundscapes. The second audio component may also be adjusted relative to the first component, such as by increasing its volume, altering its tempo, or shifting its pitch. In certain implementations, the transition from the first to the second audio component may be carried out through blending or cross-fading, ensuring that playback remains smooth and continuous as speeds change.

At block 512, the method may include outputting audio with the second audio component. The output may consist solely of the second component, or it may represent a blend of the first and second components that together form a composite audio output. By progressively introducing or modifying audio content based on detected speeds, the system adapts the auditory experience to the riding context. The resulting playback can be more immersive for the rider and can simultaneously provide auditory indicators to others of the relative speed of the ridable device.

The method 500 may be embodied in program instructions stored on a non-transitory computer-readable storage medium. When executed by one or more processors, the program instructions cause the system to perform the operations described above. The described process enables speed-based detection of motion, corresponding selection of audio components, and adaptive output of audio that reflects real-time riding conditions.

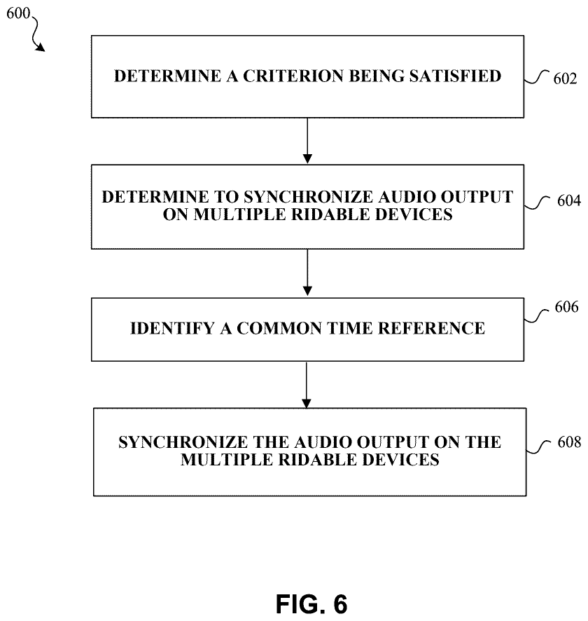

FIG. 6 is a flow diagram illustrating an example method 600 for synchronizing audio output on multiple ridable devices. The method 600 may be performed at an electronic device including at least one processor, memory, and input/output components, and may be implemented in hardware, software, or a combination thereof. The electronic device may be integrated into a ridable device, such as an electric scooter or bicycle, or may be a mobile device such as a smartphone that is mounted or otherwise coupled to the ridable device. The goal of the method is to allow multiple ridable devices to share synchronized audio playback, thereby creating a consistent listening experience for a group of riders and ensuring that any adaptive audio modifications remain uniform across devices.

At block 602, the method may include determining that a criterion has been satisfied. The criterion serves as the condition under which synchronization of audio between multiple ridable devices should occur. Examples of such criteria include a determination that the devices are associated with the same user account, that manual input has been provided by one or more users to link the devices, or that the devices have wirelessly connected to speakers that are associated with one another. In certain implementations, the criterion may also be based on environmental or contextual triggers, such as the devices being located within a shared geo-fence, or when one ridable device detects another within a threshold distance. The criterion may also involve contextual audio adjustments, such that changes to audio components or volume levels triggered on one device are mirrored across the other linked devices. Once the criterion is determined to be satisfied, the system initiates synchronization logic to ensure unified playback.

At block 604, the method may include determining to synchronize audio output on multiple ridable devices. This step may reflect the system's transition from independent operation of each device to a coordinated state. The determination may occur automatically in response to the satisfied criterion, or it may involve a combination of automatic and manual triggers, such as user confirmation on a device's interface. The system effectively establishes a logical grouping of devices that will participate in synchronized playback. At this point, the devices are prepared to coordinate their playback behaviors to ensure that audio content is aligned.

At block 606, the method may include identifying a common time reference for synchronizing audio output across the devices. The common time reference may be derived in several ways. In some implementations, the devices communicate directly with one another to negotiate a shared reference. In other cases, the devices may reach out to a coordinating server that distributes timing data to ensure precise alignment. In still further examples, the devices may rely on an external clock source, such as a GPS time signal, which provides a globally consistent reference accessible to all participating devices. Establishing a shared time reference ensures that each device is able to start, stop, and adjust playback in exact temporal alignment, thereby avoiding drift or mismatch between devices. The common reference may also be updated dynamically, for example if network conditions cause latency or if one device temporarily loses connection.

At block 608, the method may include synchronizing the audio output on the multiple ridable devices. Synchronization may be accomplished by providing each device with information regarding what content to play and when to play it, based on the established common time reference. In some implementations, one device may act as a primary unit and share playback instructions with secondary devices, while in other cases a central server coordinates the synchronization across all devices. The synchronization not only applies to the base audio content, but also to any contextual changes in playback. For example, when one device introduces a new audio component at higher riding speeds, the same adjustment may be applied consistently across all synchronized devices. Similarly, if playback volume is modified due to environmental noise on one device, the adjustment can be propagated to others. This ensures that riders experience a consistent and unified sound environment regardless of which device initiates the contextual change.

The synchronization of speed-based audio adjustments allows the auditory experience to reflect the riding context uniformly across all participants. When multiple riders are traveling together, the gradual addition of sound components such as musical riffs, melodies, sound effects, loops, or acoustic elements along with corresponding frequency range or tempo adjustments triggered by speed changes, occurs in concert across all devices. This produces a seamless group experience in which each rider perceives the same progression of audio modifications at the same time. The result is a coordinated auditory environment that strengthens the sense of shared activity and enhances environmental awareness through consistent auditory cues.

The method 600 may be implemented in a system comprising one or more processors and a non-transitory computer-readable storage medium storing program instructions. When executed, the program instructions cause the processors to carry out the operations of determining when synchronization should occur, establishing a common time reference, and coordinating playback across devices. Through these operations, FIG. 6 illustrates a system and method that extends individualized audio customization into a shared, synchronized group experience, ensuring that multiple ridable devices produce audio in temporal and contextual harmony.

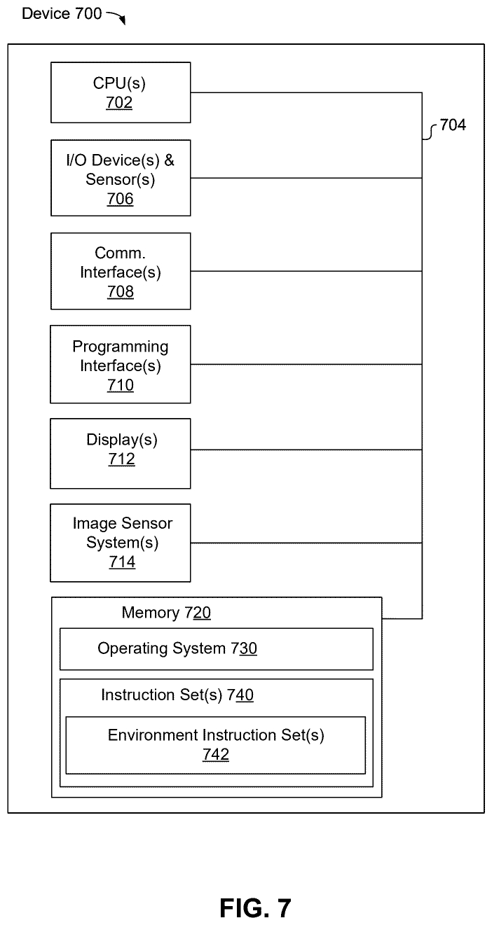

FIG. 7 illustrates an example electronic device 700 configured to execute an audio customization system that adapts playback based on contextual information associated with operation of a ridable device. The electronic device 700 may represent any suitable computing platform, such as a smartphone, tablet, embedded control module, or a control unit integrated within the ridable device. In various implementations, the device 700 processes sensor data to determine audio configuration parameters (e.g., volume, pitch, tempo, or track selection) and manages audio output delivered to one or more speakers. Contextual information used in such determinations may include, for example, speed, acceleration, orientation, ambient noise levels, or geographic location.

The device 700 includes one or more central processing units (CPUs) 702 configured to execute operating system functions and audio customization logic. The CPUs communicate with subsystems over a system bus 704. Input/output (I/O) devices and sensors 706 may include accelerometers, gyroscopes, microphones, cameras, and location sensors configured to capture motion, orientation, environmental noise, or positional data. Based on the sensor inputs, the processing logic may apply proportional volume scaling, audio mixing or blending, pitch or tempo adjustments, or geo-fence triggers for location-based playback. One or more communication interfaces 708 support wired or wireless connectivity with the ridable device, companion devices, or remote servers, while programming interfaces 710 enable integration with applications that extend or customize the rider's audio experience.

The device 700 may further include a display 712 for presenting information such as playback settings, speed, or context-based alerts to the user. In some implementations, an imaging or environmental sensing system 714 captures ambient conditions or location data to further inform audio adjustments. A memory 720 stores executable components, including an operating system 730 and an instruction set 740 implementing audio-customization functionality. The instruction set 740 may include an environment module 742 that executes methods for adapting audio output in response to detected contextual conditions.

In operation, the device 700 may determine audio adjustments by comparing detected contextual information with stored configuration profiles. For example, the system may increase playback volume proportionally with detected speed, raise audio output in response to elevated ambient noise, or blend additional tracks once a threshold speed is reached. In other implementations, the system may provide location-based content triggered by geo-fences, generate warning sounds in response to detected obstacles, or synchronize playback timing with other users using GPS or network time references.

Collectively, the device 700, associated system, and methods provide a unified framework for dynamically adapting and customizing audio output during operation of a ridable device. By combining contextual data detection, parameter determination, and audio delivery, the system enables a responsive and immersive audio experience that enhances both rider enjoyment and environmental awareness.

In support of these functions, FIG. 7 further illustrates electronic device 700, which provides an exemplary hardware configuration for implementing electronic device 700. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 710, one or more output device(s) 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 712 include one or more displays configured to present a view of a 3D environment to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 700 includes a single display. In another example, the device 700 includes a display for each eye of the user.

In some implementations, the one or more output device(s) 712 include one or more audio producing devices. In some implementations, the one or more output device(s) 612 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 712 may additionally or alternatively be configured to generate haptics.

In some implementations, the one or more image sensor systems 714 are configured to obtain image data that corresponds to at least a portion of a physical environment. For example, the one or more image sensor systems 714 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 620 comprises a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 include environment instruction set(s) 742 configured to, upon execution, identify and/or interpret user interface interactions within an environment as described herein. The instruction set(s) 740 may be embodied as a single software executable or multiple software executables.

Although the instruction set(s) 740 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can choose not to provide personal information data for targeted content delivery services. In yet another example, users can choose to not provide personal information but permit the transfer of anonymous information for the purpose of improving the functioning of the device.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some implementations, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
based on detecting that a ridable device is moving at a first speed:
selecting a first audio component of a multi-component audio content item; and
outputting audio having the first audio component;
based on detecting that the ridable device is moving at a second speed that is different than the first speed:
selecting a second audio component of the multi-component audio content item; and
outputting audio having the second audio component.

2. The method of claim 1, wherein detecting that the ridable device is moving at the first speed or the second speed comprises using a global positioning system (GPS) sensor.

3. The method of claim 1, wherein detecting that the ridable device is moving at the first speed or the second speed comprises using a motion sensor selected from the group consisting of an accelerometer, a gyroscope, or a combination thereof.

4. The method of claim 1, wherein the multi-component audio content item comprises a plurality of sound components, each corresponding to a respective musical riff, melody, sound effect, loop, acoustic element, or musical instrument, and wherein the first audio component corresponds to a first sound component and the second audio component corresponds to a different sound component.

5. The method of claim 4, wherein progressively higher speeds of the ridable device cause additional sound components, including musical riffs, melodies, sound effects, loops, acoustic elements, or musical instruments, to be incorporated into the output audio.

6. The method of claim 1, wherein the first audio component corresponds to a lower frequency range of the audio content item and the second audio component corresponds to a higher frequency range of the audio content item.

7. The method of claim 6, wherein progressively higher speeds of the ridable device cause additional frequency ranges to be introduced into the output audio, thereby producing a fuller sound at higher speeds.

8. The method of claim 1, wherein selecting the second audio component further comprises increasing a volume level of the second audio component relative to the first audio component.

9. The method of claim 1, wherein outputting audio having the first audio component and the second audio component further comprises blending the components to generate a composite audio output.

10. The method of claim 1, wherein the audio output further varies based on pitch adjustments correlated to the speed of the ridable device.

11. The method of claim 1, wherein the audio output further varies based on tempo adjustments correlated to the speed of the ridable device.

12. The method of claim 11, wherein the tempo adjustment is limited or suppressed when multiple riders are synchronously listening to a same multi-component audio content item.

13. The method of claim 1, wherein selecting the audio component further comprises applying a cross-fade transition between the first audio component and the second audio component.

14. The method of claim 1, wherein the selection of audio components based on speed provides an auditory indication to nearby persons of the ridable device's speed.

15. The method of claim 1, wherein the electronic device is integrated with the ridable device.

16. The method of claim 1, wherein the electronic device is a mobile device that is removably attached to the ridable device.

17. The method of claim 1, wherein the ridable device includes integrated speakers, and the electronic device produces the audio by transmitting audio data, via a wired or wireless connection, to the integrated speakers.

18. A device comprising:
one or more processors; and
a non-transitory computer-readable storage medium coupled to the one or more processors, the storage medium comprising program instructions that, when executed by the one or more processors, cause the system to perform operations comprising:
based on detecting that a ridable device is moving at a first speed:
selecting a first audio component of a multi-component audio content item; and
outputting audio having the first audio component;
based on detecting that the ridable device is moving at a second speed that is different than the first speed:
selecting a second audio component of the multi-component audio content item; and
outputting audio having the second audio component.

19. A method comprising:
determining to synchronize audio output on multiple ridable devices based on determining that a criterion is satisfied;
identifying a common time reference for synchronizing audio output on the multiple ridable devices; (e.g., communicating between the devices, both devices reaching out to a server, or both devices access the same clock; and
synchronizing the audio output on the multiple ridable devices.

20. The method of claim 19, wherein synchronizing the audio output on the multiple ridable devices further comprises synchronizing speed-based audio adjustments such that portions of the audio introduced or modified in response to changes in riding speed are applied consistently across the multiple ridable devices.
